(19) United States
(12) Patent Application Publication
(10) Pub. No.: US 2017/0053095 A1
(43) Pub. Date: Feb. 23, 2017

(54) SYSTEM AND METHOD FOR TRACKING MEDICATION ADHERENCE

(71) Applicant: Circadian Design, Inc., San Francisco, CA (US)

(72) Inventors: Matthew Blum, San Francisco, CA (US); Matthew Crowley, San Francisco, CA (US); Lauren Meleney, San Francisco, CA (US)

(21) Appl. No.: 15/237,383

(22) Filed: Aug. 15, 2016

Related U.S. Application Data
(60) Provisional application No. 62/207,125, filed on Aug. 19, 2015.

(51) Int. Cl. G06F 19/00; B65D 75/36; B65D 43/14; A61J 1/03; A61J 7/00

(52) U.S. Cl. CPC G06F 19/3456; A61J 1/03; A61J 7/0076; B65D 43/14; B65D 75/367; A61J 1/035

(57) ABSTRACT

One variation of a system for tracking medication adherence by a user includes: a medication device configured to receive a set of pills, to output a dynamic visual queue to consume a pill from the set of pills throughout a medication window, to detect dispensation of a pill during a medication window, and to broadcast confirmation of a medication event in response to detection of dispensation of a pill; and a native medication tracking application configured to execute on a computing device, to generate parameters of the medication window based on a medication type of the set of pills and historical medication consumption data of the user, to upload the parameters of the medication window to the medication device, and to receive confirmation of a medication event from the medication device.

### CROSS-REFERENCE TO RELATED APPLICATIONS

This application claims the benefit of U.S. Provisional Application No. 62/207,125, filed on Aug. 19, 2015, which is incorporated in its entirety by this reference.

### TECHNICAL FIELD

This invention relates generally to the field of prescription medications and more specifically to a new and useful system and method for tracking medication adherence in the field of prescription medications.

### BRIEF DESCRIPTION OF THE FIGURES

FIG. 1 is a flowchart representation of a system; and

FIG. 2 is a flowchart representation of a one variation of the system; and

FIG. 3 is a schematic representation of one variation of the system.

### DESCRIPTION OF THE EMBODIMENTS

The following description of the embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

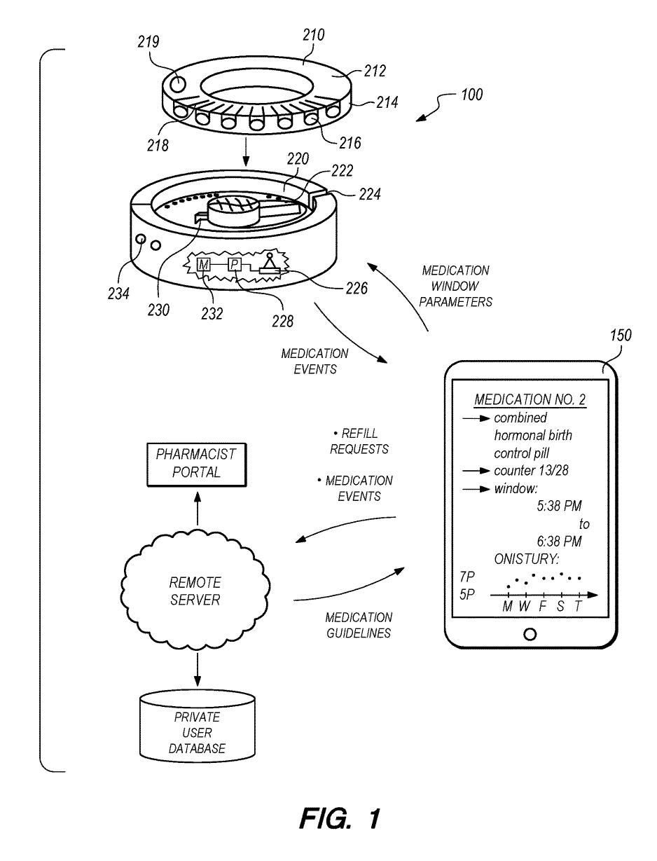

As shown in FIG. 1, a system 100 for tracking medication adherence by a user includes: a medication device 110 configured to receive a set of pills, to output a dynamic visual queue to consume a pill from the set of pills throughout a medication window, to detect dispensation of a pill during a medication window, and to broadcast confirmation of a medication event in response to detection of dispensation of a pill; and a native medication tracking application 150 configured to execute on a computing device, to generate parameters of the medication window based on a medication type of the set of pills and historical medication consumption data of the user, to upload the parameters of the medication window to the medication device 110, and to receive confirmation of a medication event from the medication device 110.

### 2. Applications

Generally, the system 100 includes a physical element and a virtual element that cooperate to prompt a user to consume a medication, to track consumption of the medication by the user, and to dynamically adjust a medication window in which the user is prompted to consume a medication in order to improve and maintain short-term and long-term adherence to a prescription for the medication. The system 100 can include one or more medication devices that: receive loose or packaged pills, such as pills sealed in an array of wells in a disposable blister pack; activate a visual display (e.g., one or more light-emitting diodes, or “LEDs”) to prompt a user to consume a medication within a limited time window (the “medication window”); detect dispensation of a pill or state changes of blisters in the disposable blister pack (e.g., from sealed to broken); transmit dispensation data to a mobile computing device executing the native medication tracking application 150 or to a remote server or computer network hosting the native medication tracking application 150; receive updated parameters for the medication window directly from the native medication tracking application 150 or from the remote server or computer network over time; and implement updated medication window parameters in subsequent medication windows. The native medication tracking application 150 can execute on a mobile computing device (e.g., a smartphone, a tablet), on a desktop computer, or on any other local or distributed computing device and can manipulate user-entered medication consumption preferences (e.g., preferred consumption time), pharmacological guidelines (e.g., responses to missed consumption, consumption time tolerance), and historical user medical consumption data to automatically adjust parameters of a subsequent medication window and to push these parameters to one or more medication devices associated with the native medication tracking application 150 (e.g., wirelessly paired with the mobile computing device). In particular, by tracking a user's adherence to a prescription and by manipulating trends in the user's adherence over time, the system 100 can modify a medication window in which visual prompts are directed to the user to remind the user to consume a medication in order to improve and maintain the user's short-term and long-term adherence to the prescription.

The system 100 is described herein as including a medication device 110 and a native medication tracking application 150 that cooperate to prompt consumption and to track dispensation of pill-form oral contraceptives. However, the system 100 can function to track consumption of any other type or form of drug or consumable, such as a prescription medication, a vitamin, a supplement, an over-the counter (OTC) drug, etc. The methods and techniques described herein as performed by the native medication tracking application 150 executing on an mobile computing device can additionally or alternatively be implemented by any other local or remote computer system, such as a remote server or a remote computer network.

### 3. Medication Device

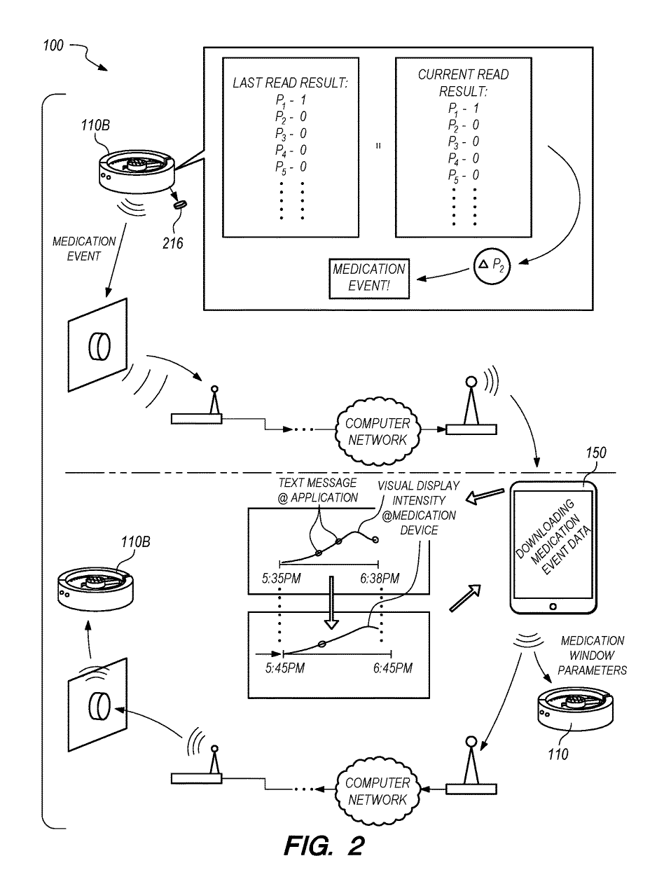

Generally, the medication device 110: functions to accept and contain pill-form medications; includes a visual display (e.g., one or more LEDs, an e-ink display) that issues a visual prompt to indicate to a user when to consume a medication from the medication device 110; includes a sensor system that detects when a pill 216 is removed from the medication device 110; and includes a wireless transmitter that pushes receipt of a pill 216 removal event to an external device, such as to a wireless communication hub (e.g., Wi-Fi router, wireless-enabled thermostat) or to a mobile computing device wirelessly-paired to the medication device 110, such as shown in FIGS. 1 and 2. The medication device 110 can additionally or alternatively include an audio driver (e.g., a speaker), a haptic feedback driver (e.g., a vibrator), or any other type of interface configured to provide a perceptible reminder or feedback to the user to consume a medication.

In one implementation, the medication device 110 is configured to accept and track pill 216 removal from a radial blister pack 210 that contains a quantity of pills in individual blisters arranged in a circular array approximately equidistant from a center of the radial blister pack 210. In this implementation, the radial blister pack 210 can include a vacuum-formed translucent polymer (e.g., PVC) structure defining a set of wells, wherein each well is configured to receive a single pill 216. Alternatively, the radial blister pack 210 can include a well structure 212 that is injection molded, drawn, or formed in any other way and in any other suitable material. Pills can then be distributed into the wells, and aluminum-foil (or perforated plastic, paper) lidding 214 can be adhered over the polymer structure of the radial blister pack 210. In one configuration, the radial blister pack 210 can define wells that extend radially outward from the center of the radial blister pack 210, and the lidding 214 can include a ring of paper- or polymer-backed aluminum foil that forms a cylindrical sheath encircling the perimeter of the polymer structure to encapsulate pills inside their respective wells.

In this configuration, the medication device 110 can include a plunger 224 proximal the center of the receptacle 222 and configured to advance and retract substantially perpendicular to the radial axis of an installed blister pack, and the center of the blister can be open to accept the plunger 224, as shown in FIG. 1. The receiver can also include a cylindrical wall 220 that encompasses the blister pack when the radial blister pack 210 is installed therein, and the cylinder wall 220 can define a break or opening aligned with the plunger 224. Thus, to remove a pill 216 from the radial blister pack 210, a user can manually advance the plunger 224, which contacts a well currently facing the opening in the cylindrical wall 220 of the receptacle 222; as the plunger 224 continues to advance, it crushes the well, breaks the lidding 214 over the well, and forces the pill 216 from the well through the opening in the cylindrical wall 220, thereby freeing the pill 216 for consumption by the user. In this configuration, the medication device 110 can also include a ratchet 230 mechanism that indexes the blister pack through a sequence of angular positions relative to the opening in the cylindrical wall 220 of the receptacle 222 in order to prepare the blister pack to dispense a next pill 216 from a next sealed well in the radial blister pack 210. For example, the ratchet 230 mechanism can be coupled to the plunger 224 such that the ratchet 230 mechanism indexes the radial blister pack 210 forward as the plunger 224 is manually advanced into a sealed well at the beginning of a dispense cycle or as the plunger 224 is returned to an initial position at the end of a dispense cycle.

In another configuration, the radial blister pack 210 can define wells that extend outwardly from a plane normal to the radial axis of the radial blister pack 210 such that a well can be crushed downward (or upward) in a direction substantially parallel to the radial axis of the blister pack to release a pill 216 from the well. In this configuration, the lidding 214 of the radial blister pack 210 can include a substantially planar sheet of paper- or polymer-backed aluminum foil adhered over the substantially planar back of the polymer structure, and the medication device 110 can include a cover hinged over the receptacle 222 and configured to enclose the blister pack within the receptacle 222. The receptacle 222 can include a window sized to pass a pill 216 from an adjacent well, and the cover can include a plunger 224 aligned with the window and configured to advance and retract substantially parallel to the radial axis of an installed blister pack. Once the blister pack is installed in the receptacle 222 and the cover closed, the user can depress the plunger 224 to crush an adjacent well, to break the aluminum foil backing behind the well, and to thus dispense a pill 216 from the well. As described above, the medication device 110 can also include a ratchet 230 mechanism coupled to the plunger 224, and the ratchet 230 mechanism can index the radial blister pack 210 forward as the plunger 224 is manually depressed into a sealed well at the beginning of a dispense cycle or as the plunger 224 is returned to an initial position at the end of a dispense cycle.

In the foregoing implementation, the blister pack can also include an array of conductive sense (e.g., low-current) traces sandwiched between paper, polymer, or other non-conductive material and applied over or integrated into the lidding 214, as shown in FIG. 1. The array of conductive sense traces 218 can define one junction over each well in the blister pack, and the conductive sense traces 218 terminate in open conductive sense pads. The radial blister pack 210 can also include a battery 219 (e.g., a coil cell battery 219) installed in a battery 219-specific well defined by the polymer sheet, installed over the lidding 214, or supported elsewhere on or within the well structure 212, and the radial blister pack 210 can include power traces extending from each terminal of the battery 219 to open conductive power pads, such as adjacent the conductive sense pads. The battery 219 can be sized according to a prescribed duration of a prescription contained in the blister pack. For example, for a blister pack containing an oral contraceptive prescription including 21 pills designated for consumption over 28 days, the blister pack can include a battery 219 of sufficient size to power the sensor system, the visual display, the wireless communication module 226, and other subsystems within the medication device 110 under greatest anticipated load—with a safety factor—over a 28-day period. In this example, once emptied at the end of the 28-day period, the oral contraceptive blister pack can be discarded, and a new oral contraceptive with a fresh, charged battery 219 can be installed in the medication device 110, thereby eliminating a need to recharged an integrated battery 219 within the medication device 110, eliminating a need to replace the medication device 110, and eliminating a need to replace a separate battery 219—in addition to the blister pack—when the separate battery 219 is fully discharged.

The medication device 110 can therefore define a receptacle 222 configured to accept a radial blister pack 210, as shown in FIG. 1. The receptacle 222 can include a set of sense and power pins (or tabs) configured to align with and contact the conductive sense and power pads on a blister pack installed in the medication device 110. As described above, the medication device 110 can include a sensor system, a memory module 232, a visual output device, a wireless communication module 226, and/or a motion sensor, etc. that are powered by a battery 219 contained within the blister pack via the conductive sense pads and power pins. The sensor system within the medication device 110 can sample resistance values across the conductive sense pads via the sense pins to determine the state of each well in the installed blister pack. For example, when a pill 216 is manually discharged from a particular well in the blister pack, a conductive trace passing over the particular well can break, thereby yielding a resistance (e.g., nearly infinite resistance) significantly greater than the resistance of other unbroken conductive traces within the blister pack. The sensor system can thus read the resistance across each conductive trace in the blister pack to determine the state (e.g., broken or unbroken) of each well in the blister pack.

The medication device 110 can also include an accelerometer, gyroscope, tilt sensor, or other motion sensor powered by the battery 219 and coupled to an interrupt pin on a processor 228 within the sensor system. When the medication device 110 is not in use, the processor 228 can enter and remain in a sleep, standby, or other low-power state. However, when the medication device 110 is handled, the motion sensor can output a sense high voltage to the interrupt pin to wake the processor 228. The medication device 110 can additionally or alternatively include a capacitive sensor and/or an ambient light sensor configured to output a signal that wakes the processor 228 when the user reaches toward the medication device 110 or when a light condition proximal the medication device 110 changes (e.g., when a light is turned on), respectively. Once awake, the processor 228 can read conductive sense traces 218 across the blister pack to determine the state of each blister pack well, such as described above. For example, the processor 228 can delay sampling conductive sense traces 218 until the motion sensor indicates that the medication device 110 has not moved for some period of time (e.g., ten seconds), then sample the conductive traces to determine the state of each well, store the state and address of each well in memory, and transition back into the sleep state. In this example, the processor 228 can also compare the state of each well in the blister pack in the current sense cycle to the state of each well in the blister pack in a last recorded sense cycle; if the current sense cycle differs from the last recorded sense cycle stored in memory (e.g., if one or more wells was determined to have been opened between the current sense cycle and the last recoded sense cycle), the processor 228 can pass the entire result of the current sense cycle—or the address and state of each specific well exhibiting a state change since the last recorded sense cycle—to the wireless communication module 226, and the wireless communication module 226 can broadcast these sense cycle data to a remote mobile computing device or other wireless-enabled remote device wirelessly paired to the medication device 110.

In the foregoing configuration, the medication device 110 can alternatively include a capacitive sensor array, a photo-emitter and photo-detector array, or an array of any other suitable sensor type patterned within the receptacle 222 and configured to output signals corresponding to the state of each well (or subset of wells) in the blister pack. Alternatively, the medication device 110 can define a single spout out of which all pills are dispensed from an installed blister pack, and the medication device 110 can include a contact or contactless sensor proximal the spout—such as an optical break beam sensor—configured to detect passage of a pill 216 through the spout. Similarly, the medication device 110 can include a position sensor coupled to a plunger 224, as described above, and the medication device 110 can correlate actuation of the plunger 224 with discharge of a pill 216 from the medication device 110.

In a similar implementation, the medication device 110 is configured to receive and track dispensation of pills from a rectilinear blister pack defining a rectilinear array of wells. For example, the medication device 110 can receive a rectilinear blister pack containing an oral contraceptive regimen of 21 pills in a rectilinear 3×7 grid array (oral contraceptive regimen of 21 active pills and seven inactive pills in a rectilinear 4×7 grid array), and the medication device 110 can include similar sensors and can implement similar methods and techniques to track removal of pills from the rectilinear blister pack.

In an alternative implementation, the medication device 110 includes a bottle configured to contain loose pills. In this implementation, the medication device 110 can include a container and a lid that cooperate to track open events, that is, instances in which the container and the lid are separated. For example, the medication device 110 can include a lid configured to engage a standard pill 216 bottle base and can include a mechanical or capacitive switch that changes its output state when the lid is installed on and removed from a standard pill 216 bottle base. Thus, when the lid of the medication device 110 is removed from a standard pill 216 bottle base, a wireless communication module 226 contained within the lid can broadcast a notice containing a lid removal prompt, timestamp, and/or removal duration, etc. to a remote device (e.g., a smartphone, Wi-Fi router, or wireless-enabled thermostat paired wirelessly to the lid) that records the medication consumption event locally and passes the medication consumption event to a remote server for handling, as described below.

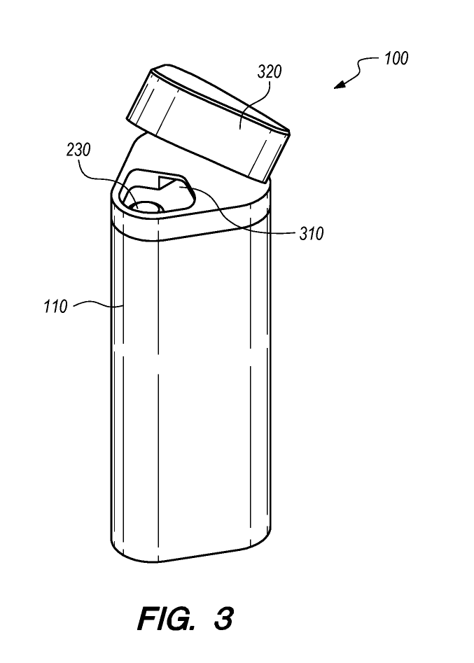

In another example, the medication device 110: defines an internal chamber 310 configured to receive a stack of pills and to dispense single pills from the stack of pills in sequence; and includes a lid 320 that pivots to expose and discharge a topmost pill 216 in the stack of pills, such as shown in FIG. 3. In this example, the medication device 110 can be configured to receive a pill cartridge 230 including: a tube; a battery 219 arranged at a base of the tube; a platform arranged over the battery 219; a spring interposed between the battery 219 and the platform and configured to displace the platform toward the top of the tube; and a cover configured to enclose a stack of pills between the platform and the top of the tube. A user can thus remove an empty cartridge from the internal chamber of the medication device 110 and then insert a fresh cartridge into the internal chamber to reload the medication device 110 with a fresh battery 219 and a new stack of pills. The user can manually remove the cover from the cartridge before or after installing the cartridge into the medication device 110, or the medication device 110 can automatically discharge the cover when the lid is first actuated after installation of the cartridge. Once the pills in the cartridge are consumed, the tube, platform, spring, and battery 219 can be removed from the medication device 110 and discarded. The medication device 110 can also read a bar code, RFID tag, ID chip, mechanical tabs, or other features applied over or integrated into the cartridge to identify the cartridge and its contents. For example, the medication device 110 can read a serial number from the cartridge, and then retrieve a medication type, origin, age, and medication window parameters for the medication contained in the cartridge from a DNS or other local or remote database based on the serial number. Alternatively, a set of loose pills can be provided to the user, and the user can manually load the loose pills into a spring-loaded magazine within the internal chamber. However, in this example, the medication device 110 can be configured for loading and reloading with pills in any other way. Furthermore, in this example, the medication device 110 can include a position sensor, limit switch, mechanical or optical break sensor, or any other suitable type of sensor that outputs a signal corresponding to the state of the lid (e.g., open or closed) or that outputs a signal corresponding to dispensation of a pill 216 from the internal chamber. The medication device 110 can thus sample the output of this sensor to detect a medication event at the medication device 110, such as in response to a change in the output of an integrated motion, light, or capacitive touch sensor, as described above.

However, the medication device 110 can define any other form factor configured to receive pills in blister pack format, in loose format, or in any other format, and the medication device 110 can detect a medication consumption event in any other suitable way.

### 4. Medication Window

When the medication device 110 and an instance of the native medication tracking application are first activated for a user, the user or affiliated entity can set a desired time to consume a prescribed medication. For example, the user can set a desired medication consumption time of 8 PM for an oral contraceptive through a settings interface within an instance of the native medication tracking application 150 executing on the user's mobile computing device (e.g., smartphone). Alternatively, a doctor, pharmacist, nurse, or other care provider affiliated with the user can set a target medication consumption time for the user, such as through a doctor portal or through a pharmacist portal accessible through a browser.

The native medication tracking application 150 can then define parameters of a medication window in which the user is prompted to consume the prescribed medication based on the medication consumption time thus entered. For example, the native medication tracking application 150 can set the medication consumption time at the start time of a medication window of preset duration (e.g., one hour), at the center of the medication window, five minutes before the end of the medication window, or at any other time within the medication window to calculate the start time of the medication window. The native medication tracking application 150 can implement a static medication window duration, such as a static preloaded medication duration of one hour. Alternatively, the native medication tracking application 150 can set the duration of the medication window based on a type of medication designated for and/or loaded into the medication device 110. For example, if the medication device 110 is loaded with combined hormonal oral contraceptive pills, the native medication tracking application 150 can set a 60-minute duration for the medication window. However, if the medication device 110 is loaded with a medication for Parkinson's Disease, the native medication tracking application 150 can set a five-minute duration for the medication window. In the foregoing implementation, the native medication tracking application can prompt the user to enter a prescription type, a prescription description, a prescription number, and/or other identifying information corresponding to the prescription loaded into the medication device 110. The native medication tracking application 150 can then pass these data into a remote database to retrieve a preset medication window duration assigned to the medication loaded into the medication device 110 and/or to retrieve other guidelines associated with the medication. Similarly, the native medication tracking application 150: can prompt the user to capture a digital photograph of a package, bar code, or other identifying information of the medication; can implement computer vision (e.g., optical character recognition) techniques to identify the medication type; and can then similarly retrieve the medication window duration from a local or remote database based on the medication type.

Alternatively, in the implementation described above in which the medication device 110 received a blister pack containing medication, the medication device 110 can include an optical sensor, a wired sensor, a RFID reader, or an other sensor configured to read a UUID, a medication type, a prescription number, or other identifying information from a blister pack or other packaging installed in the medication device 110; the medication device 110 can then upload any of these identifying data to the user's mobile computing device, such as directly or through another local computing device or through a remote server, and the native medication tracking application 150 executing on the user's mobile computing device or the remote server can retrieve a medication window duration accordingly. Yet alternatively, a doctor, pharmacist, care provider, or other affiliated entity can manually set a custom duration for the medication window, such as through a doctor portal, as described above.

The native medication application (or a remote server hosting the doctor portal, etc.) can then encrypt the selected parameters of the medication window (e.g., start time, end time, duration, etc.) and push these parameters to a remote server for storage in a private data folder assigned to the user. If the user's mobile computing device is within wireless range of the medication device 110, the native medication application can push the selected parameters of the medication window directly to the medication device 110. However, if the medication device 110 is out of range of the mobile computing device, the native medication application can push the selected medication window parameters to a local wireless hub within range of both the mobile computing device and the medication device 110, and the wireless hub can pass the medication window parameters from the mobile computing device to the medication device 110. The native medication application can also pass the medication window parameters to the remote server, which can then pass these parameters to a wireless hub or other computing device within wireless range of the medication device 110; the wireless hub or other computing device can then upload the medication window parameters to the medication device 110. Alternatively, if the medication device 110 is out of wireless range of the user's mobile computing device (or if the medication device 110 is in an off or standby mode), a wireless hub, and/or another mobile computing device, the native medication application can queue the medication window parameters for delivery to the medication device 110 when the medication device 110 is again within wireless range of the mobile computing device, the wireless hub, or the other mobile computing device and when the medication device 110 is again in an active state.

The medication device 110 can maintain an internal clock over time and can occasionally sync its internal clock with another internet-enabled device, such as each time the medication device 110 wirelessly pairs with the user's mobile computing device, with a local wireless hub, or with a local internal-enabled thermostat. The medication device 110 can then issue a visual prompt, an audible prompt, and/or an other prompt of any other type) for consumption of one or more medications contained therein based on its internal clock and the medication window parameters received from the user's mobile computing device (or other local wireless-enabled device), as described below.

### 5. Visual Prompts

In one implementation, the native medication tracking application 150 uploads a medication window to the medication device 110; the medication device 110 executes the medication window and delivers a visual medication consumption prompt throughout this window until the medication window expires or until a medication dosage is removed from the medication device 110. For example, the medication device 110 can apply a medication window of a fixed duration of one hour, as shown in FIG. 2. In this example, the medication device 110 can pulse a colored lamp (e.g., a green LED) at a frequency and brightness intensity that increases proportionally (e.g., linearly, logarithmically) from the beginning of the window to the end of the window; the medication device 110 can additionally or alternatively change the color of the colored lamp, such as from green to yellow to orange to red, over the course of the medication window. The medication device 110 can therefore provide a dynamic visual prompt to consume a medication, wherein the visual prompt is initially subtle at the start of the medication window but becomes increasingly more definitive over time. The medication device 110 can similarly issue a dynamic audible prompt that increases in intensity over time throughout the medication window until the medication window either expires or a medication consumption event is detected.

In the foregoing implementation, if the medication device 110 detects that a pill is removed from a blister pack or that the medication device 110 was opened within the window—such by detecting a state change of a well in a blister pack installed therein, as described above—the medication device 110 can generate a data packet for the medication consumption event. For example, the medication device 110 can record a date, an absolute time, and/or a relative time within the window that the pill was removed from the medication device 110 and an address of the removed pill within a blister pack. The medication device 110 can then broadcast the data packet for the medication consumption event to the user's mobile computing device, local wireless hub, or a local smart thermostat for distribution to the user's mobile computing device, a remote server, another affiliated mobile computing device, and/or to another similar medication device 110 associated with the user, as described below. However, if such a device is not within wireless range of the medication device 110 or is not suitably paired with the medication device 110, the medication device 110 can queue the data packet for later delivery to a suitable external device, as described above. For example, once the medication device 110 determines that a pill has been removed within the medication window, the medication device 110 can attempt to wirelessly connect to the user's mobile computing device, another mobile computing device, a local wireless hub, or a local smart thermostat previously associated with the medication device 110; if the medication device 110 is unable to connect with a local device within a threshold number of attempts (e.g., three attempts), the medication device 110 can transition into a sleep or standby mode and then reattempt to connect with a local device intermittently thereafter, such as every hour, until such a wireless connection is established and the data packet successfully uploaded.

The medication device 110 can also issue a visual confirmation that a medication consumption event was detected. For example, when a medication window begins, the medication device 110 can pulse a multi-color LED in an orange color and then blink the multi-color LED rapidly three times when a medication consumption event is detected in order to provide visual confirmation to the user that the event was detected.

The native medication tracking application 150 can cooperate with the medication device 110 to prompt the user to consume a medication within the medication window. For example, the native medication tracking application 150 can render a textual notification on a display of the mobile computing device at the start of the medication window, again at a halfway point within the medication window if a data packet confirming a medication consumption event is not yet received at this time, and again five minutes before expiration of the medication window, such as shown in FIG. 2. The native medication tracking application 150 can also render a virtual representation of the visual display of the medication device 110 locally on the mobile computing device and execute a color, pulse frequency, and/or brightness intensity schedule approximating that of the medication device 110 and at approximately the same time as the medication device 110 to provide a second, matched visual indicator to the user to consume the medication.

Furthermore, in response to receipt of a data packet indicating that a medication consumption event was detected at the medication device 110, the native medication tracking application 150 can also issue a notification or update a medication history chart or other graphical interface rendered on a display of the mobile computing device to provide confirmation to the user that a medication consumption event was detected, as shown in FIG. 1.

If the medication device 110 does not detect a medication consumption event before expiration of the medication window, the medication device 110 can shut down the visual display and transition into the sleep or standby mode. Alternatively, the medication device 110 can transition the visual display into a post-window state to continue to provide a visual indication to the user to consume the medication even outside of the window. In one example, in which the medication device 110 is loaded with a medication that can be consumed within an extended window of three hours with low risk of adverse side effects, the medication device 110 can slowly pulse the visual display in a low-brightness-intensity setting in an alternative color for a duration of two hours beyond the one-hour medication window to continue to provide a visual cue to the user to consume the medication while indicating that the user missed the original medication window. However, if the medication device 110 contains a medication that is time-sensitive, such as necessitating consumption within a limited time window (e.g., within the medication window), the medication device 110 can turn off the visual display and transition into the standby or sleep state if no medication consumption event is detection upon expiration of the medication. The medication device 110 can also transition the visual display into a caution state to indicate that the medication window has expired and that the user should not consume the medication. For example, the medication device 110 can set the visual display to pulse green while the medication window is active, can turn the visual display off if a medication consumption event is detected before expiration of the medication window, and can set the visual display to pulse red for a preset period of time (e.g., one hour) after expiration of the medication window if no medication consumption event is detected within the medication window.

If the medication device 110 does not detect a medication consumption event within the medication window, the medication device 110 can withhold wireless communications with the user's mobile computing device or other local wireless-enabled device, and the user's mobile computing device and/or the remote server can execute functions corresponding to absence of a medication consumption event until such a data package is received from the medication device 110. Alternatively, if no medication consumption event is detected by the medication device 110 before expiration of the medication window, the medication device 110 can transmit to the user's mobile computing device (or to another local device) a data package explicitly indicating that no medication consumption event occurred.

### 6. Medication Window Adjustments

The native medication tracking application 150 can modify the start time of a subsequent medication window based on the results of one or more previous medication consumption events. In one example, the native medication tracking application 150 (or the remote server) can: average the last seven available medication consumption times recorded by the medication device 110; can set a subsequent target medication consumption time and adjust the start and end times for the subsequent medication window accordingly; and then push the new start and end times for the medication window to the medication device 110. In this example, the native medication tracking application 150 can also compare the new target medication consumption time to a previous (e.g., immediately preceding) target medication consumption time and shift the new target medication consumption time as necessary to stay within maximum day-over-day medication window limits, such as no more than a five-minute day-over-day shift for a Parkinson's Disease medication and no more than a one-hour day-over-day shift for a combined hormonal birth control pill. The native medication tracking application 150 can thus implement a rolling target medication consumption time based on historical medication consumption data and can push or queue these data for upload to the medication device 110 before the subsequent medication window.

The native medication tracking application 150 can identify trends in the user's medication consumption behavior over time based on historical medication consumption events, can select an alternate target medication consumption time for the user if trends in the user's medication consumption behavior indicate that the user is experiencing difficulty adhering to the current medication regimen, and can modify parameters of subsequent medication windows to shift the user to the alternate medication consumption time. For example, if the user previously elected a target medication consumption time of 6 AM but has recently missed multiple medication windows encompassing this time, the native medication tracking application 150 can select an alternate target medication consumption time of 8 PM, such as based on the user's calendar; the native medication tracking application 150 can then modify start and end times of multiple subsequent medication windows to shift the user to the alternate target medication consumption time, such as over a course of fourteen days, shifting the medication window forward by one hour per day for a medication a supporting a two-hour medication window. In another example, the native medication tracking application 150 can determine that the user historically consumes a medication approximately one hour later on weekend mornings than on weekday mornings, and the native medication tracking application 150 can automatically shift the medication window forward by one hour from on Saturday mornings and one hour backward on Monday mornings.

Furthermore, the native medication tracking application 150 can modify the duration of a subsequent medication window based on the results of one or more previous medication consumption events and/or based on the user's current stage within a prescribed medication period. For example, the native medication tracking application 150 can set a one-hour medication window for a combined hormonal birth control pill when the user is in the first week and in the third week of a four-week prescribed medication period and can set a four-hour medication window for the combined hormonal birth control pill when the user is in the second week and in the fourth week of the four-week prescribed medication period. In another example, for a combined hormonal birth control pill, the native medication tracking application 150 can set a two-hour medication window for a subsequent medication consumption event if medication consumption events were detected and confirmed by the medication device 110 for the last seven days. However, in this example, the native medication tracking application 150 can set a one-hour medication window for a subsequent medication consumption event if data received from the medication device 110 indicate that the user failed to consume a birth control pill during a last medication window but successfully consumed a birth control pill during the six medication windows preceding the last medication window. Furthermore, in this example, the native medication tracking application 150 can cancel a subsequent medication window, issue a prompt (e.g., a textual notification) to the user to discard the current birth control pill pack, and to automatically order a replacement birth control pill pack from a pharmacist on behalf of the user if data received from the medication device 110 indicate that the user has missed two consecutive medication consumption events or missed two of the last seven medication consumption events. In this example, the native medication tracking application 150 can transmit a request for a complete, full replacement birth control pill pack for the medication device 110 to a pharmacist as described below. Alternatively, the native medication tracking application 150 can generate a request for a custom replacement birth control pill pack, such as including doses for a limited number of days (e.g., two weeks rather than four weeks) of a menstrual cycle set by the combined hormonal birth control.

The native medication tracking application 150 can also set notification strengths for each medication window based on the user's medication consumption history, such as by activating textual notifications throughout a medication window if the user exhibits relatively low medication adherence or risk of low medication adherence and by deactivating textual notifications throughout a medication window if the user exhibits relatively high medication adherence, as shown in FIG. 2. However, the native medication tracking application 150 can handle historical user medication adherence data in any other suitable way.

Alternatively, a remote server hosting and/or affiliated with the native medication tracking application can package the user's historical medication consumption data, present these data to a registered (human) pharmacist, nurse, doctor, or other care provider, and cooperate with the care provider to modify the medication window parameters for the user, such as through a pharmacist portal. The remote server can then push updated medication window parameters and visual display parameters to the medication device 110, such as through the native medication tracking application 150, as described above.

The native medication tracking application 150 can thus generate new medication window parameters based on historical medication consumption data and can push these updated parameters to the medication device 110 for implementation in a subsequent medication window. For example, the native medication tracking application 150 can queue the updated medication window parameters for delivery to the medication device 110 and then automatically deliver the updated medication window parameters to the medication device 110 when the medication device 110 is again within wireless range of and wirelessly pairs with the mobile computing device executing the native medication tracking application 150.

In one variation, the native medication tracking application 150 can identify instances in which the mobile computing device moves from a default (e.g., home) time zone to an alternate time zone and can prompt the user to provide a duration of a trip in the alternate time zone. The native medication tracking application 150 can then adjust the target consumption time for the medication—and therefore the medication window—based on the duration of the trip. For example, if the trip is less than 48 hours in duration, the native medication tracking application 150 can leave the original target medication consumption time unchanged. However, for trips lasting greater than 48 hours, the native medication tracking application 150 can shift the medication window forward or backward—depending on the direction of the time zone change—in order to achieve the target medication consumption time previously set for the default in the alternative time zone. For example, if the user travels from San Francisco to Chicago and the user's mobile computing device resets its clock back two hours, the native medication tracking application 150 can prompt the user to indicate a duration of the trip to Chicago. If the user responds—through an interface within the native medication tracking application 150—that the trip is eleven days long, the native medication tracking application 150 can shift the medication window backward thirty minutes per day for the first three days of the trip, thirty minutes forward per day for the last two days of the trip, and then a further thirty minutes forward per day for the first two days that the user is back in San Francisco in order to keep the user on approximately the same local target medication consumption time while staying within the maximum day-over-day medication window limits for the medication. The native medication tracking application 150 can then generate updated medication window parameters and push these parameters to the medication device 110, as described above. The native medication tracking application 150 can also implement similar methods to preemptively update medication window parameters before the user travels to a new time zone and before (or after) the user returns to the default time zone.

### 7. Multiple Medication Devices

In one implementation, the system 100 includes multiple medication devices that cooperate to track consumption of a single medication by the user across multiple locations. In one example of this implementation, the system 100 includes a first medication device 110 loaded with a first combined hormonal birth control packet for a full prescription period of 28 days and a second medication device 110B loaded with a second combined hormonal birth control packet for a full prescriptions period of 28 days. In this example, the user can store the first medication device 110 at home, can store the second medication device 110B at a second location frequented by the user, and can pair the first and second medication device 110Bs to her smartphone executing the native medication tracking application 150. The native medication tracking application 150 can generate medication window parameters, push or queue delivery parameters to both the first and second medication device 110Bs, and receive medication consumption event data from both the first and second medication device 110Bs, such as described above. The first and second medication device 110Bs can thus implement the medication window parameters to output visual prompts for a medication consumption event substantially simultaneously and in two distinct locations.

In this example, if the user removes a pill from the first medication device 110, the first medication device 110 can generate a data packet for the medication consumption event and directly or indirectly upload this data packet to the mobile computing device, as described above; the native medication tracking application 150 can then push a prompt to the second medication device 110B—such as via an Internet connection and a wireless router, smartphone, tablet, smart thermostat, or other Internet-enabled device within wireless range of and paired to the second medication device 110B—to trigger the second medication device 110B to cancel the medication window. In response to such a trigger to cancel a medication window, the second medication device 110B can shut down its visual display and transition into a sleep or standby mode. Alternatively, in response to such a medication window cancellation trigger, the second medication device 110B can transition its visual display into a cancellation mode to visually indicate that the medication was cancelled, such as by transitioning the visual display from pulsing a green color indicating that the medication window is pending to pulsing a red color for the duration of the medication window to indicate that the medication window was cancelled due to fulfillment at an alternate medication device 110 (e.g., the first medication device 110). The native medication tracking application 150 can implement similar methods and techniques to cancel the medication window at the first medication device 110 in response to receipt of a data packet for a medication consumption event detected at the second medication device 110B, and the first medication device 110 can similarly respond to a medication window cancellation trigger.

In the foregoing implementation, the user may remove pills from the first and second medication device 110Bs at a non-uniform frequency such that a prescription refill is needed at one of the medication devices before the other medication device 110. Therefore, in this implementation, the native medication tracking application 150 (or the remote server) can: reset pill number counter for a particular medication device 110 in response to receipt of a prescription replacement confirmation entered manually by the user or detected and uploaded automatically by the particular medication device 110; index the pill number counter for the particular medication device 110 in response to each medication consumption event detected at the particular medication device 110; and then automatically transmit a prescription refill prompt—including an address associated with the particular medication device 110—to a pharmacist when the pill number counter drops to a threshold number (e.g., from 28 to 7), and the pharmacist can package and ship a prescription refill to the address associated with the particular medication device 110 accordingly. In this example, the native medication tracking application 150 can alternatively generate a prescription refill prompt that includes a home address previously entered by the user. Yet alternatively, the native medication tracking application 150 can transform an IP address received with a medication consumption event data package from the particular medication device 110 into an approximate location, cross reference the approximate location with one of a set of mailing addresses previously entered by the user (or a doctor, physician, pharmacist, or other care provider on behalf of the user) to select a nearest confirmed shipping address for the particular medication device 110, and then generate a prescription refill prompt that includes the nearest confirmed shipping address. The native medication tracking application 150 can thus track medication consumption events detected across a set of medication devices assigned to or associated with the user, and the native medication tracking application 150 can automatically order prescription refills for each medication device 110 on an on-demand basis for each medication device 110 in the set of medication devices. (The native medication tracking application 150 can implement similar methods and techniques to track the status of a current prescription in a single medication device 110 and to automatically distribute a request to a pharmacist for a refill for the prescription.)

In this implementation, the native medication tracking application 150 can also monitor the user's current stage within a prescribed medication period based on medication consumption events recorded at multiple medication devices and modify medication window parameters executed by the medication devices accordingly. In the foregoing example in which the system 100 includes the first medication device 110 and the second medication device 110B, each loaded with a combined hormonal birth control packet for a full prescription period of 28 days including 21 consecutive active pill days followed by seven consecutive inactive days, the native medication tracking application 150 can monitor the user's progress throughout the 28-day prescription period based on medication consumption events recorded at both the first and second medication device 110Bs and issue textual prompts to the user—through the mobile computing device to—to remove an active pill or an inactive pill during an upcoming medication window based on whether the user is currently in the first 21 days or the latter seven days of the 28-day prescription period. In this example, the native medication tracking application 150 can additionally or alternatively push a pill type command to each medication device 110 based on the user's current stage in the prescription period, and each medication device 110 can set an output parameter of its visual display accordingly. In one example, a medication device 110 can include a set of lamps (e.g., LEDs) arranged in an array across its blister pack receptacle; the medication device 110 can thus activate a lamp adjacent or behind an active pill (or set of active pills) during a medication window in response to receipt of an active pill command from the native medication tracking application 150; and the medication device 110 can activate a lamp adjacent or behind an inactive pill (or a set of inactive pills) during a medication window in response to receipt of an inactive pill command from the native medication tracking application 150. In this example, the medication device 110 can thus manipulate a visual display of lamps to indicate a particular pill or particular subset of pills to consume during a medication window. In another example, the medication device 110 can modify a color of a visual display to indicate which pill or pill type loaded into the medication device 110 to consume during a time window, such as by setting a multicolor LED to output white light corresponding to a white active pill in response to receipt of an active pill command and by setting the multicolor LED to output red light corresponding to a red (or brown) inactive pill in response to receipt of an inactive pill command.

However, the native medication tracking application 150, one or more medication devices, and/or a remote server, etc. can cooperate in any other way to prompt the user to adhere to a prescribed medication regimen, to track the user's adherence to the prescribed medication regimen, and to automatically modify parameters of the prescribed medication regimen based on the user's historical adherence to the prescribed medication regimen.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system for tracking medication adherence by a user comprising:
a medication device configured to receive a set of pills, to output a dynamic visual queue to consume a pill from the set of pills throughout a medication window, to detect dispensation of a pill during a medication window, and to broadcast confirmation of a medication event in response to detection of dispensation of a pill; and
a native medication tracking application configured to execute on a computing device, to generate parameters of the medication window based on a medication type of the set of pills and historical medication consumption data of the user, to upload the parameters of the medication window to the medication device, and to receive confirmation of a medication event from the medication device.
